(19) United States
(12) Patent Application Publication
(10) Pub. No.: US 2002/0015054 A1
(43) Pub. Date: Feb. 7, 2002

(54) GRAPHICS DISPLAYING METHOD AND APPARATUS

(76) Inventor: SUMITAKA HIBINO, KASUGAI-SHI (JP)

Correspondence Address: STAAS & HALSEY LLP, 700 11TH STREET, NW, SUITE 500, WASHINGTON, DC, 20001, US

(21) Appl. No.: 08/801,916

(22) Filed: Feb. 14, 1997

(30) Foreign Application Priority Data
Mar. 12, 1996 (JP) 8-054731

(51) Int. Cl. G09G 5/00

(52) U.S. Cl. 345/677

(57) ABSTRACT

A graphics displaying method and apparatus having an improved operability with respect to the zooming function or panning function of graphics data is described. In one embodiment, a graphics displaying method for displaying a graphical image on a screen of a computer system using a plurality of graphics display functions, includes the operations of: recognizing positions of a start point and an end point on the screen that have been designated by an operator; selecting one of the plurality of graphics display functions based on the positions of the start point and the end point; and executing the selected graphics display function to display the graphical image on the screen.

### BACKGROUND OF THE INVENTION

1. Field of the Invention

The present invention relates generally to a graphics displaying apparatus. More particularly, the invention relates to a graphics displaying method and apparatus having an improved operability with respect to a zooming function or panning function for graphics data displayed on a graphics screen.

2. Description of the Related Art

The development of the computer technology has made it possible to display a vast amount of graphics data, such as simulation results or computer aided design (CAD) data, on a graphics screen. Because the display area of each graphics screen is limited, plural pieces of data are displayed in an overlapped manner on the screen. To permit a user or an operator to sufficiently observe the desired graphics data under such a display condition, graphics computers are given a zooming function for enlarging graphics data within a limited partial screen area or a panning display function for moving graphics data to be displayed relative to the screen area.

FIG. 1 is a flowchart illustrating a sequence of processes in a screen manipulation mode of a conventional graphics displaying apparatus.

In step 51, the graphics displaying apparatus awaits the selection of either the zooming function or panning function by an operator. In the zooming function, when the operator designates a start point and an end point on the screen, graphics data in a rectangular area defined by the start point and the end point is enlarged or zoomed up. In the panning function, when the operator designates a point (start point) on the screen, graphics data is shifted relative to the screen so that the designated point becomes the center of the display screen.

In steps 52 to 57, the graphics displaying apparatus executes a process according to the function selected by the operator and the designation of the start point and end point by the operator. The start point and end point are designated using a pointing device like a mouse. The pointing device sends three events to the graphics displaying apparatus. The first event indicates that a button of the pointing device has been depressed (indicating the designation of the start point in this case), the second event indicates that this button has been released (indicating the designation of the end point in this case), and the third event indicates that the pointing device has been moved.

When the zooming function is selected, the graphics displaying apparatus displays a rectangular rubber band, defined by the start point and end point, on the screen to clarify the area to be zoomed up by the operator in step 58. In step 59, the graphics displaying apparatus performs a process of redrawing graphics data on the screen in accordance with the selected function and the designated start point and end point.

According to the conventional method, when the operator performs the operation of zooming up graphics data more than once using the zooming function, for example, it is unnecessary to perform the operation to select the function. However, when the zooming function is switched to the panning function, the operator needs to again perform the operation to select the panning function. Such switching of functions is a burden on the operator who must handle a huge amount of graphics data. In other words, the operator is frequently forced to switch between the zooming function and the panning function. As a result, the conventional method is inefficient and frustrating to the operator given that the switching of one function to the other is needed between the operation to designate the first start point and end point and the operation to designate the next start point and end point.

### SUMMARY OF THE INVENTION

Broadly speaking, the present invention relates to a graphics displaying method and apparatus having an improved operability with respect to the zooming function or panning function of graphics data.

The present invention can be implemented in numerous ways including as an apparatus, a method, and on computer readable media. Several implementations of the invention are summarized below.

As a graphics displaying method for displaying a graphical image on a screen of a computer system using a plurality of graphics display functions, an embodiment of the invention includes the operations of: recognizing positions of a start point and an end point on the screen that have been designated by an operator; selecting one of the plurality of graphics display functions based on the positions of the start point and the end point; and executing the selected graphics display function to display the graphical image on the screen.

As a graphics displaying method for displaying a graphical image on a screen of a computer system using a plurality of graphics display functions including panning and zooming functions, another embodiment of the invention includes the operations of: displaying a graphical image and a cursor movable by an operator on the screen; recognizing a cursor position as a start point on the screen that has been designated by an operator; recognizing either a current position of the cursor before or after designation of the start point or a cursor position as an end point designated by the operator after designation of the start point; selecting either the panning function or the zooming function using one of information on the start point, information on the current position of the cursor, information on the start point and the current position of the cursor, and information on the start point and the end point; and executing the selected one of the panning function and the zooming function in accordance with designation of the end point by the operator and redrawing the graphical image on the screen.

As a graphics displaying apparatus having a plurality of graphics display functions, an embodiment of the invention includes: a display unit for displaying graphical information on a screen; an input unit operable to designate positions of a start point and an end point on the screen; and a processing unit coupled to the display unit and the input unit, the processing unit recognizes positions of the start point and the end point on the screen that are designated by an operator, selects one of the plurality of graphics display functions using information on the positions of the start point and the end point, and executes the selected graphics display function to alter the displaying of the graphical information on the screen.

As a graphics displaying apparatus having a plurality of graphics display functions including panning and zooming functions, another embodiment of the invention includes: a display unit for displaying graphical information and a cursor on a screen; an input unit operable to move the cursor and to designate positions of a start point and an end point on the screen by an operator; and a processing unit coupled to the display unit and the input unit, the processing unit operates to recognize a cursor position as a start point on the screen as designated by an operator, recognize either a current position of the cursor before or after designation of the start point or a cursor position as an end point designated by the operator after designation of the start point, select either the panning function or the zooming function using one of information on the start point, information on the current position of the cursor, information on the start point and the current position of the cursor, and information on the start point and the end point, and execute the selected one of the panning function and the zooming function in accordance with designation of the end point by the operator and redrawing the graphical information on the screen.

As a computer readable medium containing program instructions for displaying graphical data on a screen using a graphics displaying apparatus having a plurality of graphics display functions, an embodiment of the invention includes: computer readable code devices for recognizing positions of a start point and an end point on the screen that have been designated by an operator; computer readable code devices for selecting one of the plurality of graphics display functions based on information on the positions of the start point and the end point; and computer readable code devices for executing the selected graphics display function to display graphical data on the screen.

As a computer readable medium containing program instructions for displaying a graphical image on a screen of a computer system using a graphics displaying apparatus having a plurality of graphics display functions including panning and zooming functions, another embodiment of the invention includes: computer readable code devices for displaying the graphical image and a cursor movable by an operator on the screen; computer readable code devices for recognizing a cursor position as a start point on the screen that has been designated by an operator; computer readable code devices for recognizing either a current position of the cursor before or after designation of the start point or a cursor position as an end point designated by the operator after designation of the start point; computer readable code devices for selecting either the panning function or the zooming function using one of information on the start point, information on the current position of the cursor, information on the start point and the current position of the cursor and information on the start point and the end point; and computer readable code devices for executing the selected one of the panning function and the zooming function in accordance with designation of the end point by the operator and redrawing the graphical image on the screen according to the selected one of the panning function and the zooming function.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a flowchart illustrating a zooming/panning function of a conventional graphics displaying apparatus;

FIG. 2 is a diagram schematically illustrating a graphics displaying apparatus according to a first embodiment of the invention;

FIG. 3 is a flowchart illustrating the zooming/panning function of the graphics displaying apparatus according to the first embodiment;

FIG. 4 is a flowchart illustrating the zooming/panning function which follows the flowchart in FIG. 3;

FIG. 5 is a diagram showing a standard screen area when the panning function is selected;

FIG. 6 is a diagram showing a standard screen area when the panning function or the zooming function is selected;

FIG. 7A is a diagram showing a range where an X-zooming function is to be executed,

FIG. 7B is a diagram showing a range where a Y-zooming function is to be executed, and

FIG. 7C is a diagram showing a range where an XY-zooming function is to be executed;

FIG. 8A is a diagram showing a screen on which the X-panning function is designated, and

FIG. 8B is a diagram showing the screen after the execution of the X-panning function; and

FIG. 9A is a diagram showing a screen on which the XY-zooming function is designated, and

FIG. 9B is a diagram showing the screen after the execution of the XY-zooming function.

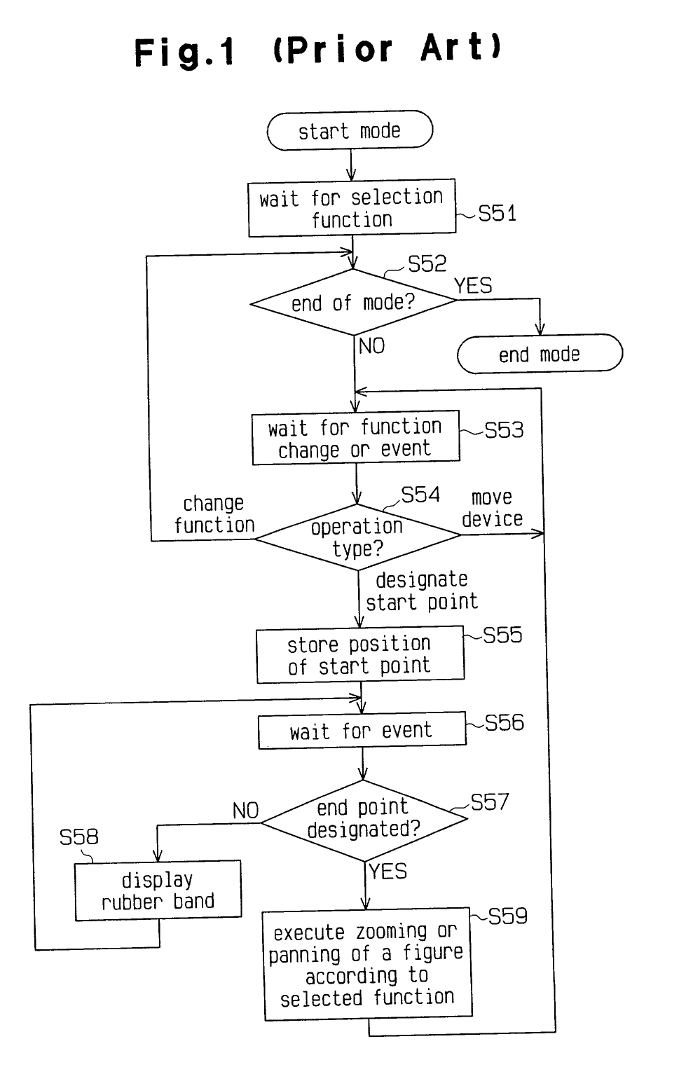

### DETAILED DESCRIPTION OF THE PREFERRED EMBODIMENTS

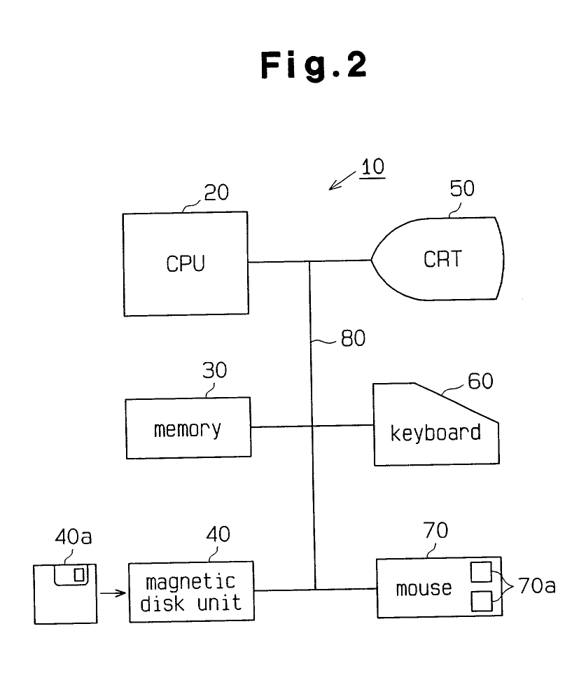

A graphics displaying apparatus according to one embodiment of the present invention will now be described referring to the accompanying drawings. FIG. 2 schematically illustrates a graphics displaying apparatus 10. The graphics displaying apparatus 10 comprises a Central Processing Unit (CPU) 20, a memory 30, a magnetic disk unit 40, a Cathode Ray Tube (CRT) 50 as a display unit, a keyboard 60 and a mouse 70 as an input unit, which are mutually connected by a system bus 80. A liquid crystal display or a plasma display may replace the CRT 50 as the display unit.

The magnetic disk unit 40 reads graphics data and a program for displaying the graphics data on the CRT 50, both stored on a magnetic disk 40a. In this embodiment, graphics data is data relating to waveforms which are previously obtained by simulation of a circuit design. The memory 30 stores the graphics data and program read by the magnetic disk unit 40. In stead of the magnetic disk unit 40, a hard disk drive may be used.

The CPU 20 operates to display the graphics data on the CRT 50 in accordance with the program read from the memory 30. The CPU 20 further performs the panning or zooming of the graphics data according to the program. In the case of panning, the embodiment copes with three panning functions: the first is the X-panning function for moving graphics data horizontally (in the X direction) relative to the screen of the CRT 50, the second is the Y-panning function for moving graphics data vertically (in the Y direction) relative to the screen, and the third is the XY-panning function for moving graphics data in the X and Y directions relative to the screen. In the case of zooming, the embodiment handles three zooming functions: the first is the X-zooming function for zooming up graphics data only in the X direction of the screen, the second is the Y-zooming function for zooming up graphics data only in the Y direction of the screen, and the third is the XY-zooming function for zooming up graphics data in both the X and Y directions of the screen.

The zooming function or the panning function is performed using the mouse 70. An operator manipulates the mouse 70 to designate a start point and an end point. Based on the designated start point and end point, the CPU 20 selects one of the X-panning function, Y-panning function, XY-panning function, X-zooming function, Y-zooming function and XY-zooming function. The CPU 20 then executes a process of moving or zooming up graphics data according to the selected function, and redraws the graphics data on the screen of the CRT 50.

The mouse 70 is a pointing device (or input unit) which the operator uses to designate a position on the screen of the CRT 50. The operator can move a graphic cursor of a predetermined shape displayed on the screen of the CRT 50 by manipulating the mouse 70. The operator can also designate the position where the graphic cursor should be displayed by operating a button 70a of the mouse 70.

The CPU 20 receives three events from the mouse 70 in accordance with the operator's manipulation of the mouse 70. The first is a movement event indicating that the mouse 70 has been moved, the second is an operation event indicating that the button 70a has been depressed, and the third is another operation event indicating that the button 70a has been released. The CPU 20 inputs the current positional information of the cursor (coordinate values) in accordance with the movement event. Further, the CPU 20 recognizes the coordinate values indicating the current cursor position as the coordinate values of the start point or the end point in accordance with the operation event (depression or releasing). In this embodiment, the CPU 20 recognizes the coordinate values indicating the current cursor position as the coordinate values of the start point in accordance with the depression event and recognizes the coordinate values indicating the current cursor position as the coordinate values of the end point in accordance with the releasing event. The cursor position when the operator depresses the button 70a of the mouse 70 and then releases it may be recognized as the start point. The cursor position when the operator depresses the button 70a of the mouse 70 and then releases it after the designation of the start point may be recognized as the end point.

The CPU 20 executes different processes in accordance with four operational states of the mouse 70 by the operator, namely, (1) the status before the designation of the start point, (2) the status upon designation of the start point, (3) the status until the end point is designated since the designation of the start point, and (4) the status upon designation of the end point.

### Before Designation of Start Point

The CPU 20 performs the selection of the panning function, the display of a mark, the alteration of the graphic cursor and the display of a string of characters by using the coordinate values of the current cursor position that changes as the mouse 70 moves. That is, the CPU 20 selects one of the X-panning function, the Y-panning function and the XY-panning function in accordance with the coordinate values of the current position. The CPU 20 further executes three processes so as to: (1) display the mark representing the selected panning function at the current cursor position, (2) display the graphic cursor whose shape corresponds to the selected function, and (3) display a string of characters representing the selected function in a predetermined area on the screen.

### Upon Designation of Start Point

The CPU 20 recognizes the coordinate values of the current position designated by the operator as the coordinate values of the start point. Based on the coordinate values of the start point, the CPU 20 performs the selection of the panning function, the display of a start point, the alteration of the graphic cursor and the display of a string of characters. Specifically, the CPU 20 selects one of the X-panning function, the Y-panning function and the XY-panning function in accordance with the coordinate values of the start point. The CPU 20 further executes three processes so as to: (1) display the mark representing the selected panning function at the start point, (2) display the graphic cursor whose shape corresponds to the selected function, and (3) display a string of characters representing the selected function in a predetermined area on the screen.

### From Designation of Start Point to Designation of End Point

During this period, the operator leaves the mouse 70 unmoved while depressing the button 70a or moves the mouse 70 while depressing the button 70a. By using the coordinate values of the designated start point and the coordinate values of the current cursor position, the CPU 20 performs the selection of the panning function, the determination of whether the panning function or zooming function is desired, the selection of the zooming function, the alteration of the graphic cursor, the display of a rubber band, and the display of a string of characters. If it is assumed that the current position is an end point, the CPU 20 determines whether the panning function or the zooming function should be performed. When it is determined that the panning function is to be executed, the CPU 20 selects one of the X-panning function, the Y-panning function and the XY-panning function. When it is determined that the zooming function is to be executed, the CPU 20 selects one of the X-zooming function, the Y-zooming function and the XY-zooming function. The CPU 20 further executes three processes so as to: (1) display the graphic cursor whose shape corresponds to the selected function, (2) display the rubber band representing the area on which the selected function is to be performed, and (3) display a string of characters representing the selected function in a predetermined area on the screen.

### Upon Designation of End Point

The CPU 20 recognizes the coordinate values of the current position designated by the operator as the coordinate values of the end point. Using the coordinate values of the start point and end point, the CPU 20 establishes the operational function and performs the redrawing process. In accordance with the coordinate values of the start point and end point, the CPU 20 determines whether the panning function or the zooming function should be performed. Based on the result of the determination, either function is selected and the selected function is then marked to be executed. The CPU 20 thereafter performs the marked function using the coordinate values of the start point and the end point.

In the aforementioned individual states, the simple designation of the start point and the end point by the operator operating the mouse 70 allows the panning function or the zooming function to be automatically selected by the CPU 20 and graphics data to be redrawn on the screen in accordance with the selected function. In other words, the operator can perform the zooming function or the panning function without performing any operation associated with the selection of the function. This feature improves the work efficiency of the operator with respect to the processing and viewing of graphics data. The display of a mark, the graphic cursor, and the string of characters indicating the selected function by the CPU 20 facilitates the confirmation of the selected function by the operator.

The selection of the panning function, the determination of whether it is the panning function or zooming function, the selection of the zooming function, the alteration of the graphic cursor, the display of the rubber band, and the display of a string of characters will now be discussed one after another.

### Selection of Panning Function

Using plural pieces of screen area data previously separated in association with the X-panning function, the Y-panning function and the XY-panning function, and the positional information (coordinate values) of the current position or the start point, the CPU 20 selects one of the panning functions. Specifically, the CPU 20 determines in which area the coordinate values of the current position or the designated start point are located, and selects one of the X-panning function, the Y-panning function and the XY-panning function based on the area where the coordinate values are located.

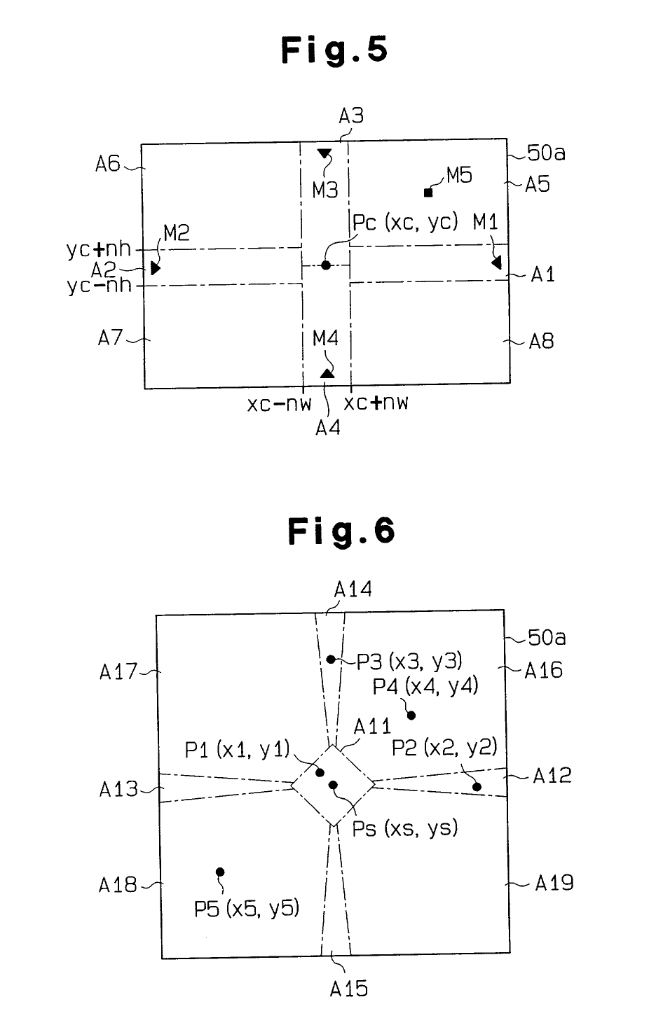

As shown in FIG. 5, for example, the screen 50a of the CRT 50 is separated into a plurality of (eight in this embodiment) areas A1 to A8. The panning function corresponding to one of the areas A1-A8 where the current position or the start point is located is selected. If the current position or the start point is located in either the right center area A1 or the left center area A2, the X-panning function is selected. If the current position or the start point is located in either the upper center area A3 or the lower center area A4, the Y-panning function is selected. If the current position or the start point is located in one of the upper right area A5, the upper left area A6, the lower left area A7 and the lower right area A8, the XY-panning function is selected.

The sizes of the areas A1-A8 are set in accordance with the size of the screen 50a (the horizontal width and the height). In this embodiment, “W” denotes the X direction of the screen 50a or the horizontal direction in FIG. 5, “h” denotes the height in the Y direction or the up and down direction in FIG. 5, and (xc, yc) represents the coordinate values of the center point, Pc, of the screen 50a.

The areas A1 and A2 for which the X-panning function is selected are defined by the following equation (1):

(yc−nh≦y≦yc+nh) and (x<xc−nw or x>xc+nw). (1)

The areas A3 and A4 for which the Y-panning function is selected are defined by the following equation (2):

xc−nw≦x<xc+nw. (2)

The areas A5 to A8 for which the XY-panning function is selected are defined by the following equation (3):

(x<xc−nw or x>xc+nw) and (y<yc−nh or y>yc+nh). (3)

In those equations, n is a constant greater than 0 and less than 1.

To determine in which one of the areas A1-A8 the current position or the start point is located, the CPU 20 determines which one of the equations (1) to (3) the coordinate values of the current position or start point satisfy. The CPU 20 selects one of the X-panning function, the Y-panning function and the XY-panning function corresponding to the satisfied one of the equations (1) to (3).

### Determination of Panning or Zooming

The CPU 20 determines whether it is the panning function or the zooming function is desired based on the distance between the start point and end point. Specifically, the CPU 20 computes the distance between the start point and the end point, and determines the panning function is desired when the distance is less than a predetermined threshold value, and determines the zooming function is desired when the distance is equal to or greater than the threshold value.

A Manhattan distance is used as information on the distance between the start point and the end point. The Manhattan distance is represented by the sum of the X-directional distance and the Y-directional distance between two points. As shown in FIG. 6, for example, a rhombus area A11 defined in a part of the screen area is the range for the threshold value with respect to the Manhattan distance. The boundary of the area A11 is formed by two orthogonal lines (not shown) having lengths of 2 d which cross the start point Ps and respectively extend in the X and Y directions where d is the threshold value. The CPU 20 determines if the end point lies in this area A11. Specifically, with (xs, ys) being the coordinate values of the start point Ps and (x, y) being the coordinate values of the end point, it is determined whether the end point lies in the area A11 according to an equation (4) given below.

|x−xs|+|y−ys|<d (4)

When the end point lies in the area A11, it is determined as “panning,” and when the end point lies out of the area A11, it is determined as “zooming”. If the end point, P1, is located at the point where the Manhattan distance from the start point Ps is less than the threshold value d, as shown in FIG. 6, the CPU 20 determines that the end point P1 lies within the area A11 and determines that it is “panning”. If the end point, any one of points P2-P5, is located at the point where the Manhattan distance from the start point Ps is equal to or greater than the threshold value d, the CPU 20 determines that the end point P2, P3, P4 or P5 is located out of the area A11 and determines that it is “zooming”.

A Euclidean distance may be used instead of a Manhattan distance to determine if it is zooming or panning. The determination of zooming or panning may also be accomplished by checking if the X-directional distance |x−xs| and the Y-directional distance |y−ys| between the start point and end point meet the following equation:

|x−xs|<m and |y−ys|<n,

where xs and ys are the coordinate values of the start point, x and y are the coordinate values of the end point, and m and n are arbitrary values. The range which satisfies this equation is expressed by a rectangle whose center is the start point and which has a length of 2×m in the x direction and a length of 2×n in the Y direction.

### Selection of Zooming Function

The CPU 20 selects the zooming function using information on the relative direction of the end point to the start point. As shown in FIG. 6, eight areas A12 to A19 which define the direction of the end point with respect to the start point are previously set on the screen 50a of the CRT 50. The CPU 20 determines in which one of the areas A12-A19 the end point lies, and selects the function associated with the area where the end point lies. The CPU 20 displays a string of characters representing the selected function in a predetermined area on the screen 50a.

A value t (=|y−ys|÷|x−xs|) which is obtained by dividing the absolute value of the difference between the y coordinates of the start point and the end point by the absolute value of the difference between the x coordinates of the start point and the end point is used as the information on the direction of the end point. That is, the value t is the absolute value of the tangent of an angle 0 between a line passing the start point and parallel to the X axis and a line connecting the start point to the end point. When the difference between the x coordinates of the start point and the end point is 0, the value t goes infinity. In this embodiment, there are two threshold values (t1 and t2: t1<t2) between 0 and infinity. The zooming function is therefore selected by using the value t and those threshold values t1 and t2. Specifically, given that (xs, ys) are the coordinate values of the start point s and (x, y) are the coordinate values of the end point e, the right and left center areas A12 and A13 for which X-zooming is selected are defined by the following equation (5):

(x≠xs) and (t<t1). (5)

The upper and lower center areas A14 and A15 for which Y-zooming is selected are defined by an equation (6) given below:

(x=xs) or (t>t2). (6)

The upper right, upper left, lower left and lower right areas A16 to A19 for which XY-zooming is selected are defined by an equation (7) given below:

(x≠xs) and (t1≦t≦t2). (7)

To determine in which one of the areas A12-A19 the end point is located, the CPU 20 determines which one of the equations (5) to (7) the value t satisfies. Further, the CPU 20 selects one of X-zooming, Y-zooming and XY-zooming which is associated with the determined single area.

When a start point Ps and an end point P2 positioned horizontal to, and on the right side to, the start point Ps are designated, as shown in FIG. 6, the value t becomes smaller than the threshold value t1 and thus satisfies the equation (5). Therefore, the end point P2 is determined to lie in the area A12 or A13 and the X-zooming function is selected.

When the start point Ps and an end point P3 positioned vertical to the start point Ps are designated, the coordinate value x3 of the end point P3 becomes equal to the X coordinate value xs of the start point Ps and the equation (6) is thus met. Therefore, the end point P3 is determined to lie in the area A14 or A15 and the Y-zooming function is selected.

When the start point Ps and an end point P4 or P5 positioned obliquely upper right or lower left to the start point Ps are designated, the value t comes between the values t1 and t2 and thus satisfies the equation (7). The end point P4 (P5) is therefore determined to lie in any one of the areas A16 to A19 and the XY-zooming function is selected.

### Display of Mark

By using the coordinate values of the current position or the start point, the CPU 20 displays a mark representing the selected panning function at the current position or the start point. When the current position is located in the upper right area A5 as shown in FIG. 5, for example, the CPU 20 displays a mark M5 representing the XY-panning function selected in the area A5 at that current position. Next, when the operator moves the graphic cursor to the right center area Al from the upper right area A5, the CPU 20 receives the movement event of the mouse 70. As a result, the current position is shifted to the area A1. The CPU 20 determines that the current position is in the area A1, and selects the X-panning function associated with the area A1. Further, the CPU 20 displays a mark M1 representing the selected X-panning function at the current position. That is, the mark indicating the function selected at the current position is displayed at that position. By displaying the mark the operator is able to visually check the panning function which is selected at the current position.

### Alteration of Graphic Cursor

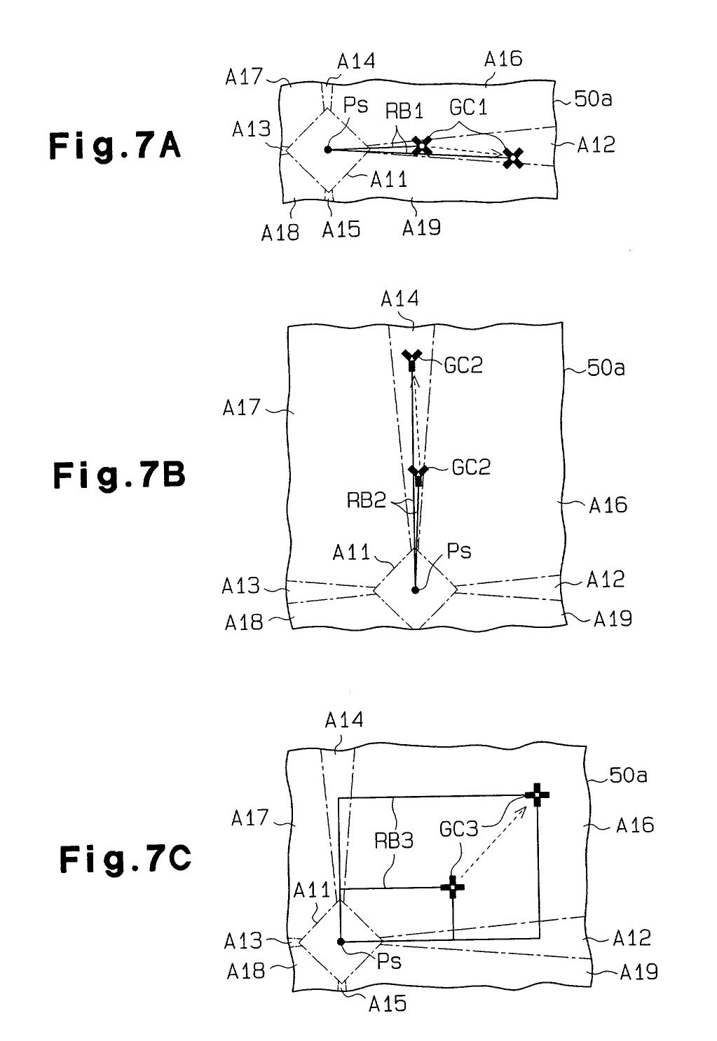

When the panning function or the zooming function is changed in the “state before the designation of the start point” or the “state from designation of the start point to the designation of the end point”, the CPU 20 displays the graphic cursor that represents the changed function. When one function is changed to the X-panning function or X-zooming function, the CPU 20 alters the display of the graphic cursor indicating the one function to the display of a graphic cursor GC1 indicating the X-panning function or X-zooming function, as shown in FIG. 7A. When one function is changed to the Y-panning function or Y-zooming function, the CPU 20 alters the displayed graphic cursor to a graphic cursor GC2 as shown in FIG. 7B. When one function is changed to the XY-panning function or XY-zooming function, the CPU 20 alters the displayed graphic cursor to a graphic cursor GC3 as shown in FIG. 7C.

When the current position lies in the area A5 shown in FIG. 5, for example, the CPU 20 displays the graphic cursor GC3 (see FIG. 7C) indicating the XY-panning function selected in that area A5. When the current position is moved to the area A1 from the area A5, the CPU 20 determines that the current position is in the area A1 according to the received movement event, and changes the XY-panning function to the X-panning function associated with the area A1. The CPU 20 then changes the graphic cursor GC3 to the graphic cursor GC1 (see FIG. 7A) representing the selected X-panning function.

In this manner, the graphic cursor which represents the currently selected panning function or zooming function is always displayed. The alteration of the display of the graphic cursor permits the operator to visually check the currently selected panning function or zooming function. Instead of altering the shape of the graphic cursor according to the selected function, the color of the graphic cursor may be changed. Further, the shape and color of the graphic cursor may both be changed.

In FIGS. 7A to 7C, actually, the mark which indicates the panning function associated with any one of the areas A1-A8 where the start point Ps is located should be displayed at the start point Ps. In this embodiment, however, a black dot is displayed at the start point Ps to emphasize the alteration of the graphic cursor representing the zooming function.

### Display of Rubber Band

When the zooming function is selected during the period from the designation of the start point to the designation of the end point, the CPU 20 displays a rubber band RB1, RB2 or RB3 connecting the start point to the current position (or the end point). When the X-zooming function is selected, the CPU 20 displays the rubber band RB1 indicated by the straight line connecting the start point Ps to the graphic cursor GC1, as shown in FIG. 7A. This rubber band RB1 indicates the range for graphics data to be displayed, zoomed up in the X direction. In the X-zooming function, graphics data is enlarged in the X direction in such a way that the start point or the end point, whichever has a smaller X coordinate value, is located at the left end of the display 50a and the point having a larger X coordinate value is located at the right end thereof.

When the Y-zooming function is selected, the CPU 20 displays the rubber band RB2 indicated by the straight line connecting the start point Ps to the graphic cursor GC2, as shown in FIG. 7B. This rubber band RB2 indicates the range for graphics data to be displayed, zoomed up in the Y direction. In the Y-zooming function, graphics data is enlarged in the Y direction in such a way that the start point or the end point, whichever has a smaller Y coordinate value, is located at the lower end of the display 50a and the point having a larger Y coordinate value is located at the upper end thereof.

When one function is changed to the XY-panning function or XY-zooming function, the CPU 20 displays the rectangular rubber band RB3 whose one orthogonal line is defined by the straight line connecting the start point Ps to the graphic cursor GC3, as shown in FIG. 7C. This rubber band RB3 indicates the range for graphics data to be displayed, zoomed up both in the X and Y directions. In the XY-zooming function, graphics data is enlarged in the X and Y directions in such a way that the start point or the end point, whichever has a smaller X coordinate value, is located at the left end of the display 50a, the point having a larger X coordinate value is located at the right end thereof, the start point or the end point, whichever has a smaller Y coordinate value, is located at the lower end of the display 50a and the point having a larger Y coordinate value is located at the upper end thereof. The display of such rubber bands RB1-RB3 permits the operator to easily check the area for graphics data to be displayed in enlargement. That is, the operator has only to designate the start point and end point in such a manner that graphics data to be displayed in enlargement overlaps the associated rubber band RB1, RB2 or RB3. Further, the rubber bands RB1-RB3 make it easier for the operator to determine the range of graphics data to be displayed in enlargement before the designation of the end point. Functions to be selected may be made distinguishable by changing the color of the rubber band. Furthermore, the color and shape of the rubber band may be altered.

### Display of String of Characters

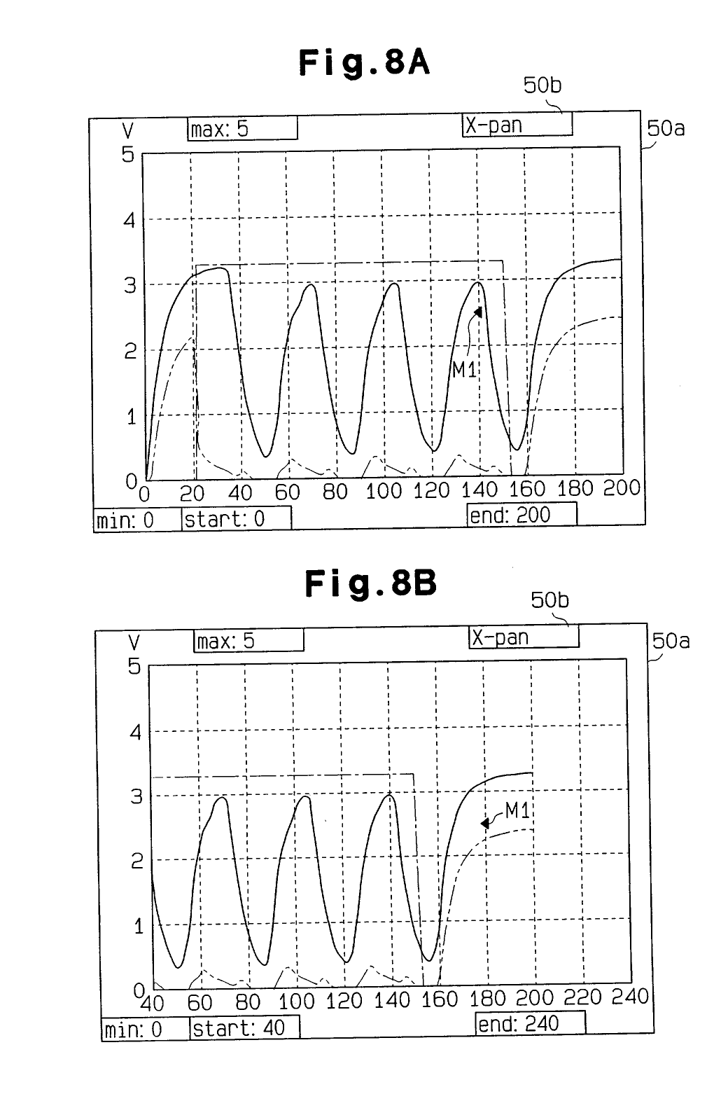

The CPU 20 displays a string of characters indicating the selected panning or zooming function in a predetermined area on the screen 50a. As shown in FIG. 8A, for example, a string of characters is displayed in an upper right area 50b on the screen 50a. It is preferable that this area 50b should be provided at the position which does not interfere with the display of graphics data and is easily seen by the operator.

In this embodiment, “X-pan” corresponding to “X-panning”, “Y-pan” corresponding to “Y-panning”, and “XY-pan” corresponding to “XY-panning” are previously stored as strings of characters indicating the panning functions. Likewise, “X-zoom” corresponding to “X-zooming”, “Y-zoom” corresponding to “Y-zooming”, and “XY-zoom” corresponding to “XY-zooming” are previously stored as strings of characters indicating the zooming functions.

As mentioned above, the marks M1-M5 to be displayed at the current position, the graphic cursors GC1-GC3 and those character strings can allow the operator to easily recognize the panning or zooming function which is selected by designating the start point and end point. This prevents the operator from making an erroneous selecting operation. The display of a string of characters may be designed to be selectable by the operator as needed.

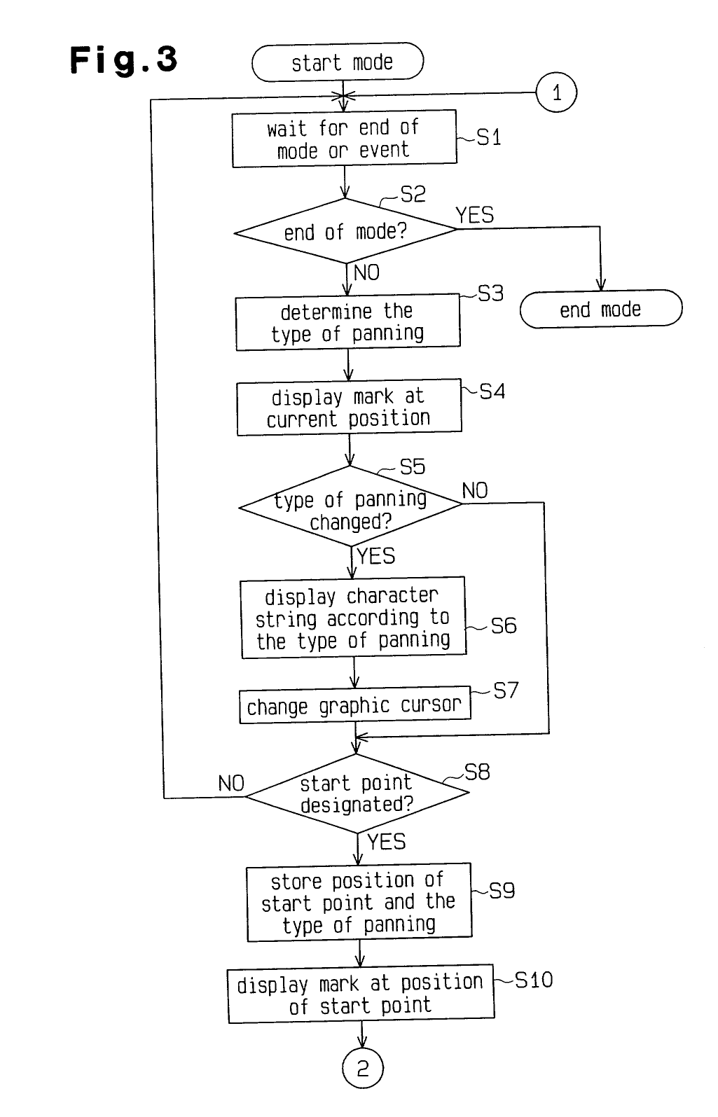

The operation of the above-described graphics displaying apparatus 10 will now be discussed referring to the accompanying drawings. As shown in FIG. 3, the CPU 20 waits for the selection of the “end of mode” or any event of the mouse 70 in step 1. The “end of mode” is selected by the operator manipulating the keyboard 60 or the mouse 70 to click the “end of mode” (not shown) displayed on the screen 50a.

In step 2, the CPU 20 determines whether or not the “end of mode” has been selected. When the “end of mode” has been selected, the CPU 20 terminates the screen operation mode for panning. When an event is input through the mouse 70, the CPU 20 moves to step 3 from step 2.

In step 3, the CPU 20 determines the panning function to be selected in accordance with the coordinate values of the current cursor position. In the next step 4, the CPU 20 displays the mark indicating the selected panning function at the current position. When the current position is determined to lie in the area A1 as shown in FIG. 7A, for example, the X-panning function associated with that area A1 is selected and the mark M1 representing the X-panning function is displayed.

Referring again to FIG. 3, the CPU 20 determines in step 5 if the selected panning function has been changed. When the panning function has been changed, the CPU 20 executes processes in steps 6 and 7 and goes to step 8. When the panning function has not been changed, the CPU 20 proceeds to step 8 from step 5.

In step 6, the CPU 20 displays a string of characters indicating the altered panning function in the predetermined area 50b on the screen of the CRT 50. In the subsequent step 7, the CPU 20 displays the graphic cursor indicating the altered panning function. In this embodiment, either one of the mark and the graphic cursor is displayed in FIGS. 7A, 7B, 8A and 8B since the simultaneous display of the mark and the graphic cursor makes it difficult to see the graphics data.

In step 8, the CPU 20 determines if the input event indicates a start point. When the event does not indicate the start point, the CPU 20 returns to step 1, whereas when the event indicates the start point, the CPU 20 proceeds to step 9.

In step 9, the CPU 20 stores the coordinate values of the current position as the coordinate values of the start point. The CPU 20 further temporarily stores the type of the panning function to be selected in accordance with the coordinate values of the current position. In the next step 10, the CPU 20 displays the mark indicating the selected panning function at the position of the start point.

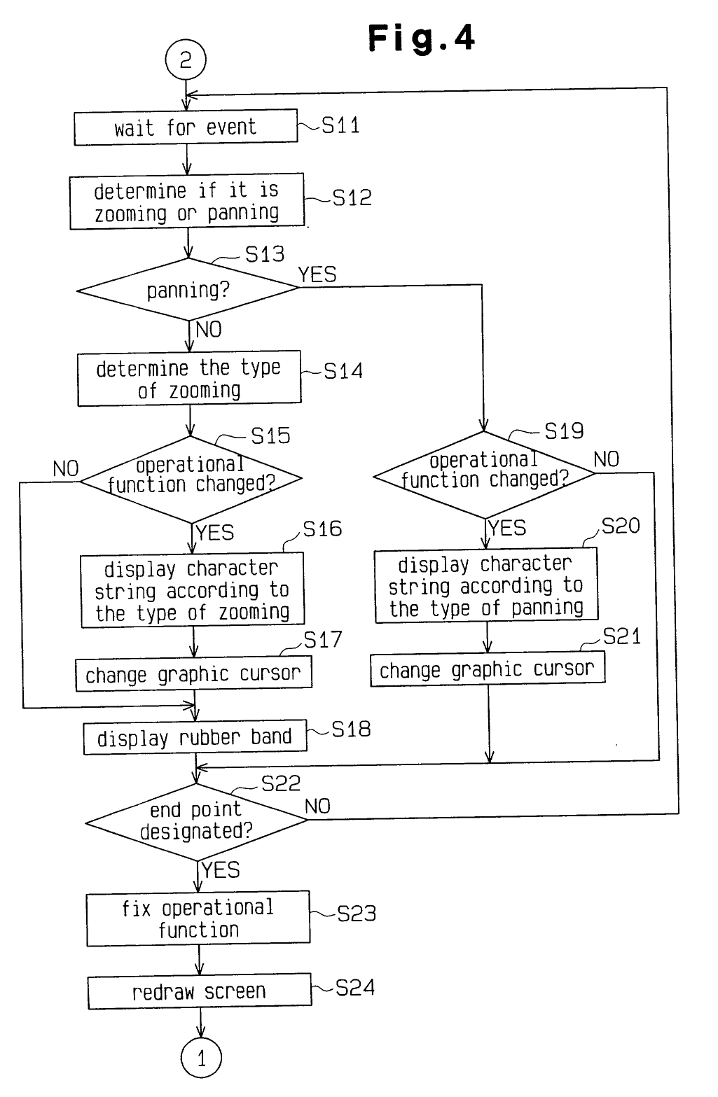

As shown in FIG. 4, the CPU 20 waits for the next event from the mouse 70 in step 11. When the CPU 20 receives a movement event indicating the movement of the mouse 70 or an operation event indicating the release of the button 70a, the CPU 20 proceeds to step 12. In step 12, the CPU 20 computes the Manhattan distance between the start point and the end point by using the coordinate values of the start point and the coordinate values of the current position or the coordinate values of the end point. The CPU 20 further determines if the Manhattan distance is smaller than the predetermined threshold value d, i.e., if the coordinate values of the current position or the end point lies in the threshold area A11. Through this determination, it is determined whether the function is panning or zooming.

When the zooming function is determined in step 13, the CPU 20 performs a sequence of processes in steps 14 to 18. When the panning function is determined, on the other hand, the CPU 20 performs a sequence of processes in steps 19 to 21. The sequence of processes in steps 19-21 will be discussed first.

In step 19, the CPU 20 determines if the function to be selected has been changed to another function using the coordinate values of the start point and the coordinate values of the current position or the end point. When the current position is shifted into the area A11 by the operator's manipulation of the mouse 70 after the temporary selection of the zooming function, for example, the zooming function is changed to the panning function. Specifically, after designation of the start point, the operator moves the graphic cursor to an area outside the area A11 to execute the zooming function. This cursor movement causes the string of characters, the graphic cursor and the rubber band all representing the zooming function to be displayed through processes in steps 16 to 18, which will be discussed later. When the XY-zooming function is selected, for example, the character string “XY-zoom”, the graphic cursor GC3 and the rubber band RB3 are displayed.

In this situation, however, the operator may need to perform the panning function, not the zooming function. In this case, to execute the panning function, the operator should move the graphic cursor into the area A11 while depressing the button 70a of the mouse 70. Then, the CPU 20 displays the string of characters and the graphic cursor which represent the panning function. When the X-panning function is selected, for example, the CPU 20 displays the character string “X-pan” in the area 50b in step 20 and displays the graphic cursor GC1 in step 21.

In step 22, the CPU 20 determines if the input event indicates an end point. When the input event does not indicate the end point and the operator keeps moving the graphic cursor, the CPU 20 returns to step 11. When the input event indicates the end point, the CPU 20 fixes the function to be selected in accordance with the coordinate values of the end point in step 23.

In the subsequent step 24, the CPU 20 executes the fixed function and redraws graphics data on the screen. When the start point and end point are designated at the display position of the mark M1 as shown in FIG. 8A, for example, the CPU 20 fixes the X-panning function in step 23. The CPU 20 further executes the X-panning function and redraws graphics data so that the X coordinate value of the mark Ml becomes the center coordinate value of the screen 50a (see FIG. 8B) in step 24.

The sequence of processes in steps 14-18 will now be discussed.

In step 14, the CPU 20 determines the zooming function to be selected using the coordinate values of the current position or the end point. In the next step 15, the CPU 20 determines if the zooming function to be selected has been changed to another zooming function. The CPU 20 displays a string of characters representing the altered zooming function in the area 50b in step 16. In step 17, the CPU 20 displays the graphic cursor which represents the altered zooming function. In the subsequent step 18, the CPU 20 displays the rubber band which connects the start point to the graphic cursor in accordance with the selected or changed zooming function.

When the mark M4 is displayed at the position of the start point as shown in FIG. 9A, for example, the CPU 20 stores the Y-panning function associated with the start point. Suppose that the operator has moves the graphic cursor to the upper right area of the screen 50b. Since the current position lies in the upper right area with respect to the start-point mark M4, the CPU 20 determines that the function to be selected is “XY-zooming”, and displays the graphic cursor GC3 and the string of characters “XY-zoom” both representing the XY-zooming function. The CPU 20 further displays the rectangular rubber band RB3 whose one orthogonal line is the straight line connecting the start-point mark M4 to the graphic cursor GC3.

Referring again to FIG. 4, after the execution of the process in step 18, the aforementioned processes in steps 22 to 24 are performed. When the mark M4 indicates the start point and the graphic cursor GC3 indicates the end point as shown in FIG. 9A, the CPU 20 fixes the XY-zooming function in step 23. In step 24, the CPU 20 executes XY-zooming and redraws graphics data in such a manner that the coordinate values of the start-point mark M4 is positioned at the lower left end of the screen 50a and the coordinate values of the end-point graphic cursor GC3 is positioned at the upper right end of the screen 50a (see FIG. 9B).

Although only one embodiment of the present invention has been described herein, it should be apparent to those skilled in the art that the present invention may be embodied in many other specific forms without departing from the spirit or scope of the invention. Particularly, it should be understood that the invention may be embodied in the following forms.

The mouse may be replaced with another pointing device, such as a tablet, a track ball, a write pen, a touch panel or a joystick. Further, the keyboard may be used instead of such a pointing device.

This invention may be adapted not only to the graphics displaying apparatus for displaying simulation results but also to ordinary CAD systems to design LSIS, printed circuit boards and the like.

Therefore, the present examples and embodiment are to be considered as illustrative and not restrictive and the invention is not to be limited to the details given herein, but may be modified within the scope and equivalence of the appended claims.

What is claimed is:

1. A graphics displaying method for displaying a graphical image on a screen of a computer system using a plurality of graphics display functions, said method comprising the steps of:
recognizing positions of a start point and an end point on said screen that have been designated by an operator;
selecting one of said plurality of graphics display functions based on said positions of said start point and said end point; and
executing said selected graphics display function to display the graphical image on said screen.

2. The graphics displaying method according to claim 1, further comprising the step of displaying a mark representing said selected graphics display function at least one of said start point and said end point on said screen.

3. The graphics displaying method according to claim 2, wherein said mark display step includes a step of displaying said mark whose color differs according to said selected graphics display function.

4. The graphics displaying method according to claim 1, further comprising the step of displaying a graphic cursor representing said selected graphics display function at least one of said start point and said end point on said screen.

5. The graphics displaying method according to claim 4, wherein said graphic cursor display step includes a step of displaying a graphic cursor whose color differs according to said selected graphics display function.

6. The graphics displaying method according to claim 1, further comprising the step of displaying a string of characters representing said selected graphics display function in a predetermined area on said screen.

7. The graphics displaying method according to claim 1, wherein the graphical image is a figure.

8. The graphics displaying method according to claim 1, wherein the graphical image pertains to a simulation of an electronic circuit.

9. A graphics displaying method for displaying a graphical image on a screen of a computer system using a plurality of graphics display functions including panning and zooming functions, said method comprising the steps of:
displaying a graphical image and a cursor movable by an operator on said screen;
recognizing a cursor position as a start point on said screen that has been designated by an operator;
recognizing either a current position of said cursor before or after designation of said start point or a cursor position as an end point designated by said operator after designation of said start point;
selecting either said panning function or said zooming function using one of information on said start point, information on said current position of said cursor, information on said start point and said current position of said cursor, and information on said start point and said end point; and
executing the selected one of said panning function and said zooming function in accordance with designation of said end point by said operator and redrawing the graphical image on said screen.

10. The graphics displaying method according to claim 9, further comprising the step of displaying a mark representing the selected one of said panning function and said zooming function at least one of said start point, said current position of said cursor, and said end point on said screen.

11. The graphics displaying method according to claim 10, wherein said mark display step includes a step of displaying said mark whose color differs according to said selected graphics display function.

12. The graphics displaying method according to claim 9, further comprising the step of displaying a graphic cursor representing the selected one of said panning function and said zooming function at least one of said start point, said current position of said cursor, and said end point on said screen.

13. The graphics displaying method according to claim 12, wherein said graphic cursor display step includes a step of displaying a graphic cursor whose color differs according to said selected graphics display function.

14. The graphics displaying method according to claim 9, further comprising the step of displaying a string of characters representing the selected one of said panning function and said zooming function in a predetermined area on said screen.

15. The graphics displaying method according to claim 9, wherein said panning function includes a plurality of types of panning functions, and
wherein said method further comprises the step of selecting one of said plurality of types of panning functions using one of said information on said current position of said cursor, said information on said start point, said information on said start point and said current position of said cursor, and said information on said start point and said end point.

16. The graphics displaying method according to claim 15, wherein said plurality of types of panning functions include an X-panning function for moving said graphical image in a horizontal direction relative to said screen, a Y-panning function for moving said graphical image in a vertical direction relative to said screen, and an XY-panning function for moving said graphical image in horizontal and vertical directions relative to said screen.

17. The graphics displaying method according to claim 9, wherein said zooming function includes a plurality of types of zooming functions, and
wherein said method further comprises the step of selecting one of said plurality of types of zooming functions using one of said information on said current position of said cursor, said information on said start point, said information on said start point and said current position of said cursor, and said information on said start point and said end point.

18. The graphics displaying method according to claim 17, wherein said plurality of types of zooming functions include an X-zooming function for zooming up said graphical image in a horizontal direction relative to said screen, a Y-zooming function for zooming up said graphical image in a vertical direction relative to said screen, and an XY-zooming function for zooming up said graphical image in horizontal and vertical directions relative to said screen.

19. The graphics displaying method according to claim 9, further comprising the step of displaying a rubber band connecting said start point to said end point when said zooming function is selected in said selecting step.

20. A graphics displaying apparatus having a plurality of graphics display functions, comprising:
a display unit for displaying graphical information on a screen;
an input unit operable to designate positions of a start point and an end point on said screen; and
a processing unit coupled to said display unit and said input unit, said processing unit operates to:
recognizes positions of said start point and said end point on said screen that are designated by an operator,
selects one of said plurality of graphics display functions using information on said positions of said start point and said end point, and
executes said selected graphics display function to alter the displaying of the graphical information on said screen.

21. The graphics displaying apparatus according to claim 20, wherein said processing unit displays a mark representing said selected graphics display function at least one of said start point and said end point on said screen.

22. The graphics displaying apparatus according to claim 21, wherein said processing unit displays said mark whose color differs according to said selected graphics display function.

23. The graphics displaying apparatus according to claim 20, wherein said processing unit displays a graphic cursor representing said selected graphics display function at least one of said start point and said end point on said screen.

24. The graphics displaying apparatus according to claim 20, wherein said processinng unit displays a graphic cursor whose color differs according to said selected graphics display function.

25. The graphics displaying apparatus according to claim 20, wherein said processinng unit displays a string of characters representing said selected graphics display function in a predetermined area on said screen.

26. The graphics displaying apparatus according to claim 20, wherein the graphical image is a figure.

27. The graphics displaying apparatus according to claim 20, wherein the graphical image pertains to a simulation of an electronic circuit.

28. A graphics displaying apparatus having a plurality of graphics display functions including panning and zooming functions, comprising:
a display unit for displaying graphical information and a cursor on a screen;
an input unit operable to move said cursor and to designate positions of a start point and an end point on said screen by an operator; and
a processing unit coupled to said display unit and said input unit, said processing unit operates to:
recognize a cursor position as a start point on said screen as designated by an operator,
recognize either a current position of said cursor before or after designation of said start point or a cursor position as an end point designated by said operator after designation of said start point,
select either said panning function or said zooming function using one of information on said start point, information on said current position of said cursor, information on said start point and said current position of said cursor, and information on said start point and said end point, and
execute the selected one of said panning function and said zooming function in accordance with designation of said end point by said operator and redrawing the graphical information on said screen.

29. The graphics displaying apparatus according to claim 28, wherein said processinng unit operates to display a mark representing the selected one of said panning function and said zooming function at least one of said start point, said current position of said cursor, and said end point on said screen.

30. The graphics displaying apparatus according to claim 29, wherein said processing unit operates to display said mark whose color differs according to said selected graphics display function.

31. The graphics displaying apparatus according to claim 28, wherein said processing unit operates to display a graphic cursor representing the selected one of said panning function and said zooming function at least one of said start point, said current position of said cursor, and said end point on said screen.

32. The graphics displaying apparatus according to claim 31, wherein said processing unit operates to display a graphic cursor whose color differs according to said selected graphics display function.

33. The graphics displaying apparatus according to claim 28, wherein said processing unit operates to display a string of characters representing the selected one of said panning function and said zooming function in a predetermined area on said screen.

34. The graphics displaying apparatus according to claim 28, wherein said panning function includes a plurality of types of panning functions, and
wherein said processing unit operates to select one of said plurality of types of panning functions using one of said information on said current position of said cursor, said information on said start point, said information on said start point and said current position of said cursor, and said information on said start point and said end point.

35. The graphics displaying apparatus according to claim 34, wherein said plurality of types of panning functions include an X-panning function for moving said graphical image in a horizontal direction relative to said screen, a Y-panning function for moving said graphical image in a vertical direction relative to said screen, and an XY-panning function for moving said graphical image in horizontal and vertical directions relative to said screen.

36. The graphics displaying apparatus according to claim 28, wherein said zooming function includes a plurality of types of zooming functions, and
wherein said processinng unit operates to select one of said plurality of types of zooming functions using one of said information on said current position of said cursor, said information on said start point, said information on said start point and said current position of said cursor, and said information on said start point and said end point.

37. The graphics displaying apparatus according to claim 36, wherein said plurality of types of zooming functions include an X-zooming function for zooming up said graphical image in a horizontal direction relative to said screen, a Y-zooming function for zooming up said graphical image in a vertical direction relative to said screen, and an XY-zooming function for zooming up said graphical image in horizontal and vertical directions relative to said screen.

38. The graphics displaying apparatus according to claim 28, wherein said processinng unit operates to display a rubber band connecting said start point to said end point when said zooming function is selected.

39. A computer readable medium containing program instructions for displaying graphical data on a screen using a graphics displaying apparatus having a plurality of graphics display functions, said computer readable medium comprising:
computer readable code devices for recognizing positions of a start point and an end point on said screen that have been designated by an operator;
computer readable code devices for selecting one of said plurality of graphics display functions based on information on said positions of said start point and said end point; and
computer readable code devices for executing said selected graphics display function to display graphical data on said screen.

40. A computer readable medium containing program instructions for displaying a graphical image on a screen of a computer system using a graphics displaying apparatus having a plurality of graphics display functions including panning and zooming functions, said computer readable medium comprising:
computer readable code devices for displaying the graphical image and a cursor movable by an operator on said screen;
computer readable code devices for recognizing a cursor position as a start point on said screen that has been designated by an operator;
computer readable code devices for recognizing either a current position of said cursor before or after designation of said start point or a cursor position as an end point designated by said operator after designation of said start point;
computer readable code devices for selecting either said panning function or said zooming function using one of information on said start point, information on said current position of said cursor, information on said start point and said current position of said cursor and information on said start point and said end point; and
computer readable code devices for executing the selected one of said panning function and said zooming function in accordance with designation of said end point by said operator and redrawing the graphical image on said screen according to the selected one of said panning function and said zooming function.
